(19) United States
(12) Patent Application Publication
(10) Pub. No.: US 2025/0219991 A1
(43) Pub. Date: Jul. 3, 2025

(54) PROXY ADDRESS RESOLUTION PROTOCOL SUPPORT IN MULTI-LINK DEVICES

(71) Applicant: Cisco Technology, Inc., San Jose, CA (US)

(72) Inventors: Eric Levy-Abegnoli, Valbonne (FR); Pascal Thubert, Roquefort-les- Pins (FR); Sachin D. Wakudkar, St-Sulpice (CH); Jerome Henry, Pittsboro, NC (US); Jegan Manoharan, Bangalore (IN)

(73) Assignee: Cisco Technology, Inc., San Jose, CA (US)

(21) Appl. No.: 18/786,259

(22) Filed: Jul. 26, 2024

(30) Foreign Application Priority Data
Dec. 29, 2023 (IN) 202341089903

(51) Int. Cl. H04L 61/5069; H04L 61/103; H04L 61/5053

(52) U.S. Cl. CPC H04L 61/5069; H04L 61/103; H04L 61/5053

(57) ABSTRACT

Proxy Address Resolution Protocol (ARP) support and specifically to providing proxy ARP support in Access Point (AP) Multi-Link Devices (MLDs) may be provided. Proxy ARP support can include, in response to a Multi-Link Operation (MLO) reconfiguration, waiting for a period. After the period, it is determined a removed link was removed during the MLO reconfiguration. A proxy ARP request associated with the removed link is dropped, and proxy ARP reconfiguration is performed. A proxy ARP cache is maintained based on the proxy ARP reconfiguration.

### RELATED APPLICATION

Under provisions of 35 U.S.C. § 119 (e), Applicant claims the benefit of and priority to Indian Provisional Application No. 202341089903, filed Dec. 29, 2023, the disclosure of which is incorporated herein by reference in its entirety.

### TECHNICAL FIELD

The present disclosure relates generally to providing proxy Address Resolution Protocol (ARP) support and specifically to providing proxy ARP support in Access Point Multi-Link Devices.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for proxy Address Resolution Protocol (ARP) support in accordance with aspects of the present disclosure.

FIG. 2 is a block diagram of a signaling process to provide proxy ARP support in accordance with aspects of the present disclosure.

FIG. 3 is a block diagram of an example multi-link element for requesting proxy ARP reconfiguration in accordance with aspects of the present disclosure.

FIG. 4 is a flow chart of a method for proxy ARP support in accordance with aspects of the present disclosure.

FIG. 5 is a block diagram of a computing device in accordance with aspects of the present disclosure.

FIG. 6 is a block diagram of a wireless device in accordance with aspects of the present disclosure.

### DETAILED DESCRIPTION

### Overview

Proxy Address Resolution Protocol (ARP) support and specifically to providing proxy ARP support in Access Point (AP) Multi-Link Devices (MLDs) may be provided. Proxy ARP support can include, in response to a Multi-Link Operation (MLO) reconfiguration, waiting for a period. After the period, it is determined a removed link was removed during the MLO reconfiguration. A proxy ARP request associated with the removed link is dropped, and proxy ARP reconfiguration is performed. A proxy ARP cache is maintained based on the proxy ARP reconfiguration.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Address Resolution Protocol (ARP) is a communication protocol that can be used to discover link layer address, such as Internet Protocol (IP) addresses and Media Access Control (MAC) addresses. A proxy device on a network, such as an Access Point (AP), can use the proxy ARP to receive and process ARP queries such as IPv4 ARP requests, IPv6 Neighbor Discovery (ND) address lookups, IPv6 ND duplicate address detection messages, and so on. If the destination address of an ARP query is known, the proxy device can respond directly on behalf of a Station (STA) or forward the request to the intended STA. For example, a device on a first subnetwork may broadcast an ARP request on the first subnetwork to reach a destination device on a second subnetwork for the destination device to send its MAC address. The broadcast may be received by a proxy device, such as an AP. An AP typically does not forward broadcasts to other subnetworks, so the destination device may not receive the broadcast. However, the proxy device may know the address of the destination device and know it can reach the destination device to determine to send its MAC address to the device on the first subnetwork. The device on the first subnetwork can then use the AP's MAC address to transmit to the destination device via the AP.

An AP Multi-Link Device (MLD) can support proxy ARP at the MLD level. Current standards describe the operation of an AP MLD that supports proxy ARP, such as requiring all APs affiliated with the AP MLD to have the same setting of the Proxy ARP field in the Extended Capabilities element (e.g., set to one when proxy ARP is enabled). However, the standards do not describe how an AP MLD maintains the proxy ARP cache in the event of a Multi-Link Operation (MLO) reconfiguration. For example, the device (e.g., a controller, an AP) implementing the proxy ARP function can learn an IP binding through Dynamic Host Configuration Protocol (DHCP). But the link where the IP address was learned can be removed through MLO reconfiguration while a non-AP MLD remains associated. The binding to the non-AP MLD will therefore be lost, and the device implementing the proxy ARP function may be forced to forward ARP requests to the non-AP MLD over the air, defeating the purpose of implementing proxy ARP.

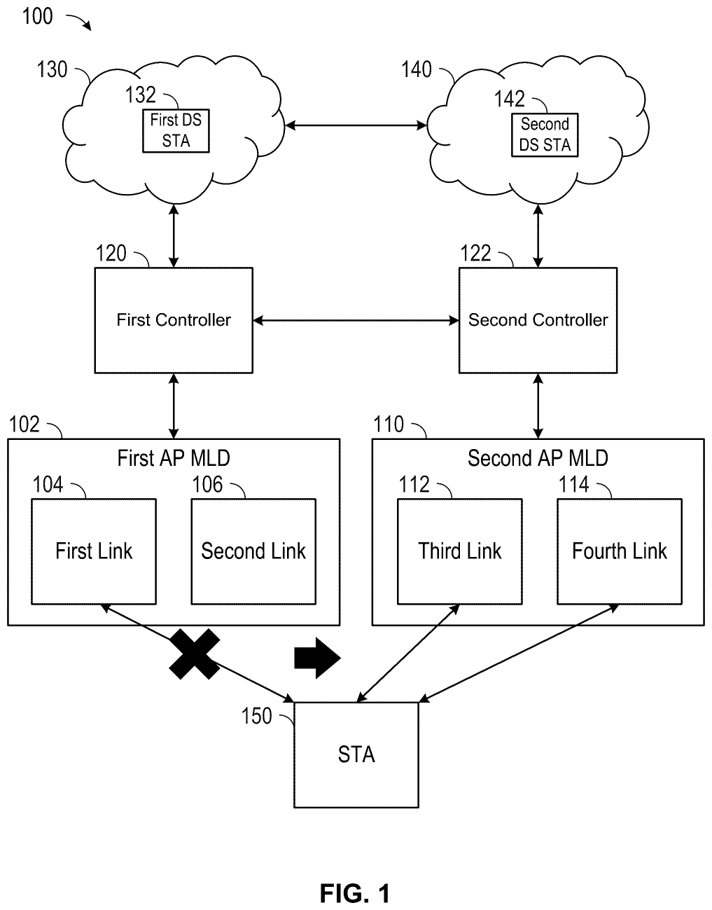

FIG. 1 is a block diagram of an operating environment 100 for proxy ARP support. The operating environment 100 includes a first AP MLD 102 with a first link 104 and a second link 106 and a second AP MLD 110 with third link 112 and a fourth link 114. The first AP MLD 102 and the second AP MLD 110 may enable devices to connect to devices and applications of the network via the first link 104, the second link 106, the third link 112, and/or the fourth link 114. The first AP MLD 102 and the second AP MLD 110 can allow concurrent connections and data transfer in multiple channels across one or more frequency bands, aggregating the available bandwidth. Thus, the first link 104 and the second link 106 may be connections in different channels across one or more frequency bands. The third link 112 and the fourth link 114 similarly can be connections in different channels across one or more frequency bands.

The operating environment 100 also includes a first controller 120, a second controller 122, a first Distribution System (DS) 130, a first DS STA 132, a second DS 140, a second DS STA 142, and a STA 150. The first controller 120 and the second controller 122 can be any network controller, such as a Wireless Local Area Network (WLAN) controller. The first DS 130 and the second DS 140 can enable the interconnection of multiple APs. Thus, first DS 130 and the second DS 140 can have one or more STAs connected to the network, including the first DS 130 having the first DS STA 132 and the second DS 140 having the second DS STA 142. The first DS 130 and the second DS 140 may be other subnetworks in certain embodiments. The first DS STA 132, the second DS STA 142, and the STA 150 can be any device (e.g., a smart phone, a tablet, a personal computer, a server, an AP, etc.) that connects to the network, such as to communicate with other devices on the network. The STA 150 may be a non-AP MLD capable of connecting to the network via multiple links.

There may be a different number of devices is other embodiments. For example, the operating environment 100 may include multiple STAs 150, more STAs in the first DS 130, more STAs ins the second DS 140, more AP MLDs, a different number of controllers, and/or the like. The AP MLDs may therefore provide proxy ARP support for multiple STAs. The first AP MLD 102 and the first controller 120 may be associated with the first DS 130, and the second AP MLD 110 and the second controller 122 may be associated with the second DS 140 in some example implementations. The first AP MLD 102 and the second AP MLD 110 may both communicate with devices of the first DS 130 and the second DS 140.

The first AP MLD 102, the second AP MLD 110, the first controller 120, and/or the second controller 122 can support proxy ARP and address any requirements that arise because of MLO to maintain proxy ARP support. The AP MLDs and/or the controllers can maintain a proxy ARP cache (i.e., a list of IP addresses and MAC addresses for devices associated with the subnetwork of the respective AP MLD, such as the first DS 130 or the second DS 140) and enable devices, such as the STA 150, to communicate with other device using proxy ARP using multiple links. The first AP MLD 102, the second AP MLD 110, the first controller 120, and/or the second controller 122 may interchangeably perform the proxy ARP support operations described herein because the proxy ARP service can be hosted and/or managed by the first AP MLD 102, the second AP MLD 110, the first controller 120, and/or the second controller 122.

To communicate with an STA of the first DS 130 or second DS 140, such as the first DS STA 132 or the second DS STA 142 the STA 150 can request the IP address(es) for the destination STA. For example, the STA 150 may request the IPv4 address of the first DS STA 132 via a link to either the first AP MLD 102 or the second AP MLD 110 and request the IPv6 address of the first DS STA 132 via an additional link to either the first AP MLD 102 or the second AP MLD 110. Using proxy ARP, the first AP MLD 102 and/or the second AP MLD 110 can identify whether the IPv4 and IPv6 addresses of the first DS STA 132 are known and, if the addresses are known, the first AP MLD 102 and/or the second AP MLD 110 can provide their own IPv4 and IPv6 addresses to the STA 150. The STA 150 can then use the IPv4 and IPv6 addresses of the first AP MLD 102 and/or the second AP MLD 110 to communicate with the first DS STA 132.

In an example embodiment, the STA 150 receives the IPv4 address of the first AP MLD 102 via the first link 104 as proxy for the IPv4 address of the first DS STA 132 and the IPv6 address of the second AP MLD 110 via the fourth link 114 as proxy for the IPv6 address of the first DS STA 132. However, during MLO reconfiguration, such as if a link of the STA 150 is deleted and replaced, the first AP MLD 102, the second AP MLD 110, the first controller 120, and/or the second controller 122 may maintain the proxy ARP cache, share updates between APs to maintain bindings for MLD IP addresses, and/or the like to continue providing proxy ARP support. For example, when removing an existing link via the first AP MLD 102 using the first link 104 and creating a new link via the second AP MLD 110 using the third link 112, the second AP MLD 110 and/or the second controller 122 may update the proxy ARP cache to maintain the connection to the first DS STA 132 using the IPv4 address.

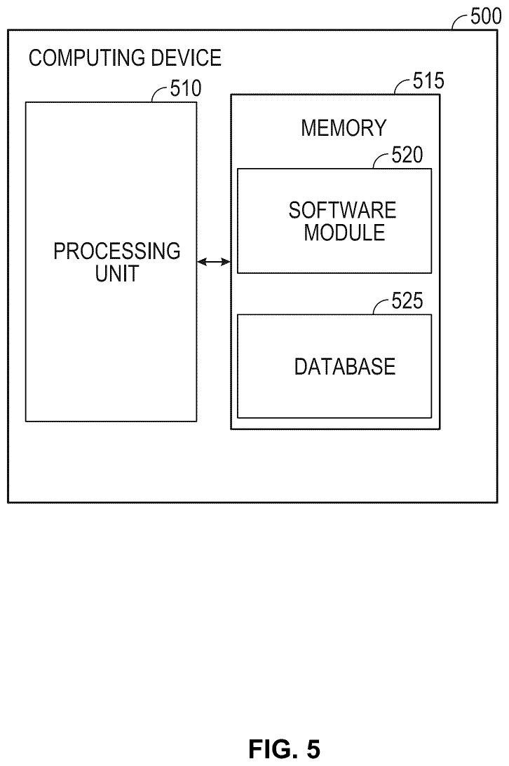

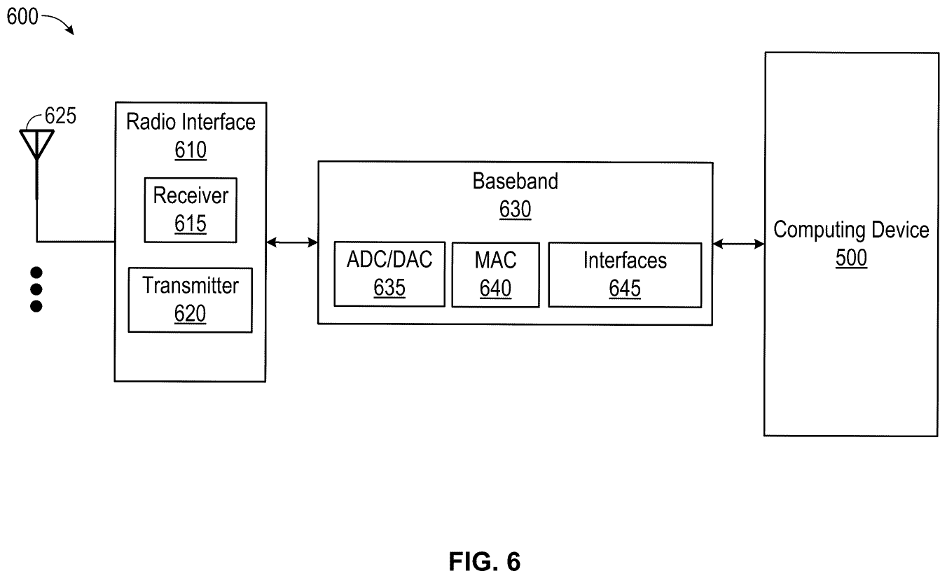

The elements described above of the operating environment 100 (e.g., the first AP MLD 102, the second AP MLD 110, the first controller 120, the second controller 122, the first DS STA 132, the second DS STA 142, the STA 150, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

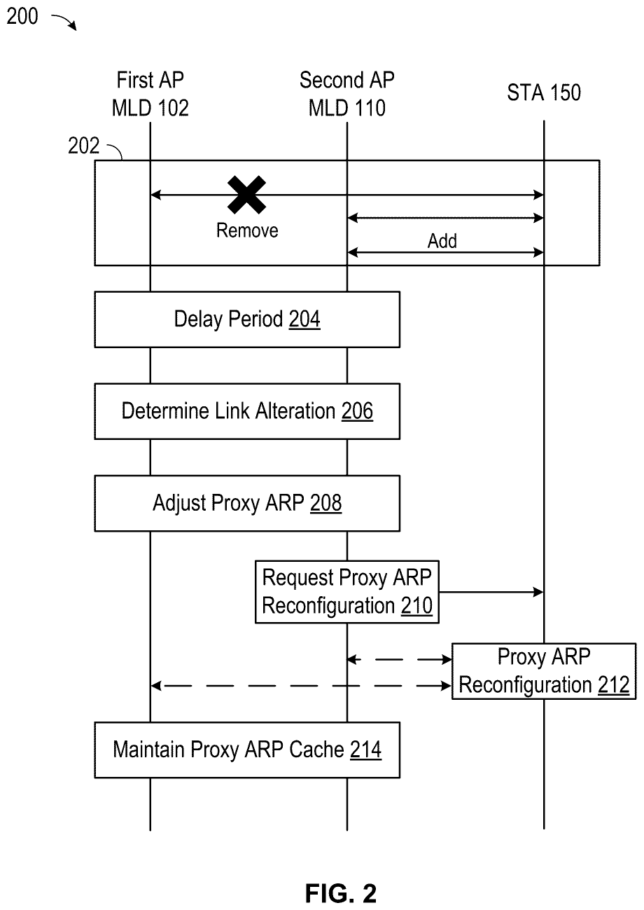

FIG. 2 is a block diagram of a signaling process 200 to provide proxy ARP support. The signaling process 200 can include operations for the first AP MLD 102, the second AP MLD 110, the first controller 120, and/or the second controller 122 to maintain proxy ARP support with the implementation of MLO.

The first AP MLD 102 and the second AP MLD 110 can employ MLO to add and remove links to the STA 150 dynamically without requiring the STA 150 to re-associate. The signaling process 200 can begin with an MLO reconfiguration 202. The MLO reconfiguration 202 can include procedures the first AP MLD 102 and/or the second AP MLD 110 perform to remove a link or add a link, such as for the STA 150. For example, the STA 150 may have the connection via the first link 104 removed and the connection via the third link 112 added.

To maintain proxy ARP support, the first AP MLD 102 and/or the second AP MLD 110 can wait for a period to determine if a link, such as the link of the STA 150 via the first link 104, was permanently removed after the MLO reconfiguration 202. For example, the first AP MLD 102 and or the second AP MLD 110 may perform the delay period in operation 204, waiting for a period before evaluating the MLO reconfiguration 202. The period can be predefined, dynamic based on a length of time typically required to determine whether a link is permanently deleted, and/or the like. Waiting to determine if a link is removed can enable the first AP MLD 102 and/or the second AP MLD 110 to only alter the operation of the proxy ARP service when a MLO reconfiguration affects the links, thereby preventing unnecessary changes to the proxy ARP service.

After the delay period, the first AP MLD 102 and/or the second AP MLD 110 can determine a link alteration in operation 206, evaluating the MLO reconfiguration 202. If the link is permanently removed, the first AP MLD 102 and/or the second AP MLD 110 can adjust the proxy ARP in operation 208 and drop communications involving proxy ARP, such as ARP and ND requests, if the bindings (e.g., IP bindings learned through DHCP) are not found in the proxy ARP service. The bindings may be lost because of the removal of the link during the MLO reconfiguration.

In certain embodiments, the first AP MLD 102 and/or the second AP MLD 110 can trigger the STA 150 to perform proxy ARP reconfiguration by sending a proxy ARP reconfiguration request in operation 210. The proxy ARP reconfiguration can include the STA 150 sending ARP requests and/or a DHCP request to renew (i.e., re-learn or re-validate) the IP address associated with the deleted link post MLO reconfiguration 202. The proxy ARP reconfiguration request can identify the addresses that need to be re-learned or re-validated. For example, the proxy ARP reconfiguration can include the STA 150 re-learning or re-validating the IPv4 address the STA 150 was using to communicate with the first DS STA 132 via the removed link (e.g., the first link 104). The second AP MLD 110 may provide a new IPv4 address or validate the existing IPv4 address so the STA 150 can continue communicating with the first DS STA 132 using the new link (e.g., via the third link 112). Validating an existing address can include the AP MLDs communicating the address being used and the associated address of the device to be communicated with.

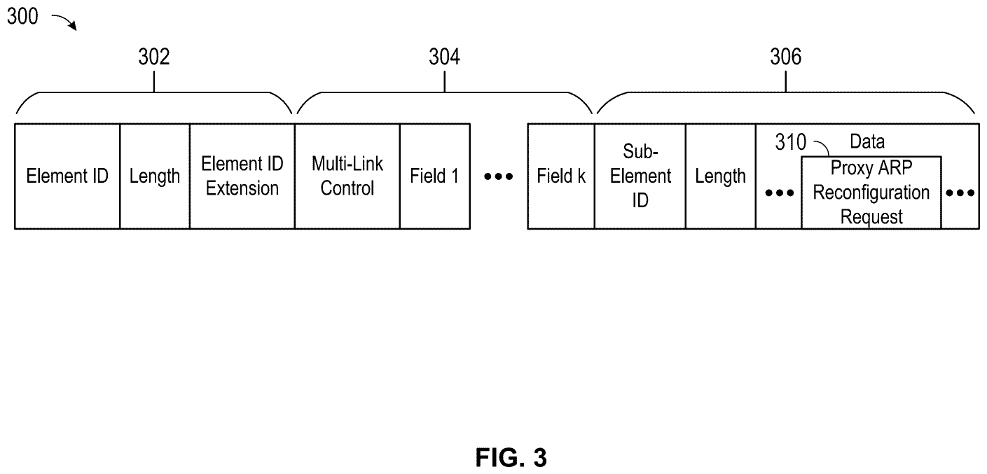

The proxy ARP reconfiguration request can be included in a per-STA profile sub-element (e.g., one or more Information Elements (IEs)) of a multi-link element). An example proxy ARP reconfiguration request is included in the example multi-link element 300 shown in FIG. 3. The multi-link element 300 includes header IEs 302, common IEs 304, and a per-STA profile sub-element 306. The header IEs 302, common IEs 304, and per-STA profile sub-element 306 can enable MLD setup and operation, for example between the first AP MLD 102, the second AP MLD 102, and/or the STA 150. The header IEs 302 can include an element ID IE, a length IE, an element ID extension IE, and/or the like. The common IEs 304 can include a multi-link control IE, one or more field IEs, and/or the like. The per-STA profile sub-element 306 can include a sub-element ID IE, a length IE, a data IE with one or more fields, including a proxy ARP reconfiguration request 310, and/or the like.

The proxy ARP reconfiguration request 310 can request the associated STA (e.g., the STA 150) to re-learn or re-validate the addresses the associated STA uses to communicate with. For example, the proxy ARP reconfiguration request 310 can instruct the STA 150 to re-learn or re-validate the IPv4 address the STA 150 was using to communicate with the first DS STA 132 via the removed link (e.g., the first link 104). The second AP MLD 110 may provide a new IPv4 address or validate the existing IPv4 address so the STA 150 can continue communicating with the first DS STA 132 using the new link (e.g., via the third link 112).

In certain embodiments, a non-AP MLD such as the STA 150 can detect the MLO reconfiguration 202 without receiving a request (e.g., the proxy ARP reconfiguration request). Thus, the proxy ARP reconfiguration request may not need to be sent and operation 210 not performed, because the STA 150 can perform proxy ARP reconfiguration in response to detecting the MLO reconfiguration 202. The first AP MLD 102 and/or the second AP MLD 110 may not need to send the multi-link element 300 when the STA 150 can detect the MLO reconfiguration 202.

Referring back to FIG. 2, the first AP MLD 102 and/or the second AP MLD 110 can maintain the proxy ARP cache in operation 214. In example implementations, the first AP MLD 102 and/or the second AP MLD 110 can maintain the proxy ARP cache once the STA 150, and any other STAs affected by the MLO reconfiguration 202, has performed proxy ARP reconfiguration. Maintaining the proxy ARP cache in operation 214 can include removing the old address(es) the STA 150 was using to communicate with other devices (e.g., the first DS STA 132, the second DS STA 142) and adding the new address(es) the STA 150 will now use to communicate with other devices. Thus, the first AP MLD 102 and/or the second AP MLD 110 can provide proxy ARP support using the maintained proxy ARP cache.

When an AP MLD determines an address over a link, such as the second AP MLD 110 determining the IPv6 address using the fourth link 114, the AP MLD can update the other AP MLD links so that the proxy ARP service maintains the binding for each MLD address. The AP MLD may share the determined address with other AP MLDs using a wired connection the other AP MLDs in example implementations. In certain embodiments, a multicast group can be created for each MLD link so that updates including address updates can be communicated. The AP MLDs and/or controllers can share updates via a wired connection the other devices in example implementations.

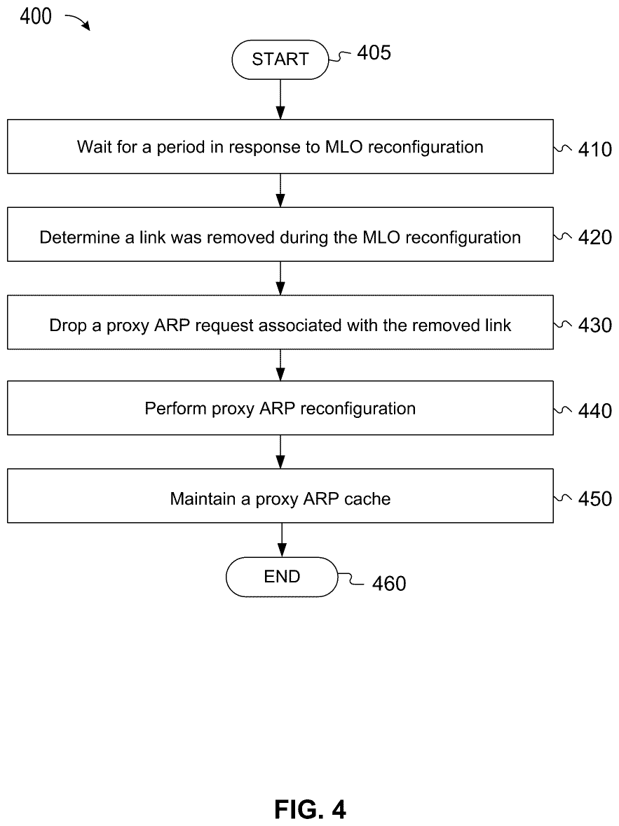

FIG. 4 is a flow chart of a method 400 for proxy ARP support. The method 400 can begin at starting block 405 and proceed to operation 410. In operation 410, in response to an MLO reconfiguration, waiting for a period. For example, the AP MLDs and/or controllers wait for a period in response to the MLO reconfiguration 202 to ensure any removed links are permanently down. The period may have a predetermined length, may be dynamic based on a determined time it takes for links to reconnect, and/or the like.

In operation 420, after the period, it is determined link was removed during the MLO reconfiguration. For example, the AP MLDs and/or controllers determine a link of the STA 150 is removed, such as to the first link 104. The AP MLDs and/or controllers may also determine that links are added during the MLO reconfiguration.

In operation 430, a proxy ARP request associated with the removed link is dropped. For example, the AP MLDs and/or controllers may drop ARP requests and/or ND requests if the address binding associated with the request in removed or otherwise not found. The ARP requests and/or ND requests may not be able to be properly handled without the address binding.

In operation 440, proxy ARP reconfiguration is performed. For example, the AP MLDs and/or the controllers renew (e.g., re-learn or re-validate) links associated with the removed link and any new links. The proxy ARP reconfiguration can include sending a proxy ARP reconfiguration request to the STA 150 associated with the removed link. In response to the proxy ARP reconfiguration request, the AP MLDs and/or the controllers can receive from the STA 150 a proxy ARP request, a DHCP request, and/or the like to renew an address associated with the removed link. The proxy ARP reconfiguration request can be in a per-STA profile sub-element 306 of a multi-link element 300 in example implementations. In other embodiments, the STA 150 can identify when MLO reconfiguration 202 occurs. Thus, the STA 150 may send the proxy ARP request, a DHCP request, and/or the like without a proxy ARP reconfiguration request.

In operation 450, a proxy ARP cache is maintained based on the proxy ARP reconfiguration. For example, the AP MLDs and/or controller update the proxy ARP cache to remove any addresses associated with the removed link that cannot be used anymore and adds any addresses associated with a new link that have been determined. Any new addresses learned during proxy ARP reconfiguration can be shared or otherwise updated with other MLD links. A multicast group of one more MLD links can be created for sharing address updates created or otherwise learned during proxy ARP reconfiguration. The method 400 can conclude at ending block 460.

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for providing proxy ARP with MLO with respect to FIG. 1, FIG. 2, FIG. 3, and FIG. 4. Computing device 500, for example, may provide an operating environment for the first AP MLD 102, the second AP MLD 110, the first controller 120, the second controller 122, the first DS STA 132, the second DS STA 142, the STA 150, and the like. The first AP MLD 102, the second AP MLD 110, the first controller 120, the second controller 122, the first DS STA 132, the second DS STA 142, the STA 150, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

FIG. 6 illustrates an implementation of a communications device 600 that may implement one or more of the first AP MLD 102, the second AP MLD 110, the first controller 120, the second controller 122, the first DS STA 132, the second DS STA 142, the STA 150, etc., of FIGS. 1-3. In various implementations, the communications device 600 may comprise a logic circuit. The logic circuit may include physical circuits to perform operations described for one or more of the first AP MLD 102, the second AP MLD 110, the first controller 120, the second controller 122, the first DS STA 132, the second DS STA 142, the STA 150, etc., of FIGS. 1-3, for example. As shown in FIG. 6, the communications device 600 may include one or more of, but is not limited to, a radio interface 610, baseband circuitry 630, and/or the computing device 500.

The communications device 600 may implement some or all of the structures and/or operations for the first AP MLD 102, the second AP MLD 110, the first controller 120, the second controller 122, the first DS STA 132, the second DS STA 142, the STA 150, etc., of FIGS. 1-3, storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHYsical layer (PHY) processing circuit for the PHY link layer processing of respective receive/transmit signals. Baseband circuitry 630 may include, for example, a Media Access Control (MAC) processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
in response to a Multi-Link Operation (MLO) reconfiguration, waiting for a period;
after the period, determining a removed link was removed during the MLO reconfiguration;
dropping a proxy Address Resolution Protocol (ARP) request associated with the removed link;
performing proxy ARP reconfiguration; and
maintaining a proxy ARP cache based on the proxy ARP reconfiguration.

2. The method of claim 1, wherein dropping the proxy ARP request associated with the removed link comprises determining an address binding associated with the proxy ARP request is removed.

3. The method of claim 1, wherein performing ARP reconfiguration comprises:
sending a proxy ARP reconfiguration request to a Station (STA) associated with the removed link;
in response to the proxy ARP reconfiguration request, receiving from the STA any one of (i) a proxy ARP request, (ii) a Dynamic Host Configuration Protocol (DHCP) request, or (iii) a combination of (i) and (ii) to renew an address associated with the removed link; and
renewing the address associated with the removed link.

4. The method of claim 3, wherein the proxy ARP reconfiguration request is included in a per-STA profile sub-element of a multi-link element.

5. The method of claim 1, wherein performing ARP reconfiguration comprises:
receiving any one of (i) a proxy ARP request, (ii) a Dynamic Host Configuration Protocol (DHCP) request, or (iii) a combination of (i) and (ii) to renew an address associated with the removed link; and
renewing the address associated with the removed link.

6. The method of claim 1, further comprising:
updating a new address learned during the proxy ARP reconfiguration with one or more Multi-Link Device (MLD) links.

7. The method of claim 1, further comprising:
creating a multicast group of one or more MLD links for sharing address updates created during the proxy ARP reconfiguration.

8. A system comprising:
a memory storage; and
a processing unit coupled to the memory storage, wherein the processing unit is operative to:
in response to a Multi-Link Operation (MLO) reconfiguration, wait for a period;
after the period, determine a removed link was removed during the MLO reconfiguration;
drop a proxy Address Resolution Protocol (ARP) request associated with the removed link;
perform proxy ARP reconfiguration; and
maintain a proxy ARP cache based on the proxy ARP reconfiguration.

9. The system of claim 8, wherein to drop the proxy ARP request associated with the removed link comprises to determine an address binding associated with the proxy ARP request is removed.

10. The system of claim 8, wherein to perform ARP reconfiguration comprises to:
send a proxy ARP reconfiguration request to a Station (STA) associated with the removed link;
in response to the proxy ARP reconfiguration request, receive from the STA any one of (i) a proxy ARP request, (ii) a Dynamic Host Configuration Protocol (DHCP) request, or (iii) a combination of (i) and (ii) to renew an address associated with the removed link; and
renew the address associated with the removed link.

11. The system of claim 10, wherein the proxy ARP reconfiguration request is included in a per-STA profile sub-element of a multi-link element.

12. The system of claim 8, wherein performing ARP reconfiguration comprises to:
receive any one of (i) a proxy ARP request, (ii) a Dynamic Host Configuration Protocol (DHCP) request, or (iii) a combination of (i) and (ii) to renew an address associated with the removed link; and
renew the address associated with the removed link.

13. The system of claim 8, the processing unit being further operative to:
update a new address learned during the proxy ARP reconfiguration with one or more Multi-Link Device (MLD) links.

14. The system of claim 8, the processing unit being further operative to:
create a multicast group of one or more MLD links for sharing address updates created during the proxy ARP reconfiguration.

15. A non-transitory computer-readable medium that stores a set of instructions which when executed perform a method executed by the set of instructions comprising:
in response to a Multi-Link Operation (MLO) reconfiguration, waiting for a period;
after the period, determining a removed link was removed during the MLO reconfiguration;
dropping a proxy Address Resolution Protocol (ARP) request associated with the removed link;
performing proxy ARP reconfiguration; and
maintaining a proxy ARP cache based on the proxy ARP reconfiguration.

16. The non-transitory computer-readable medium of claim 15, wherein:
wherein dropping the proxy ARP request associated with the removed link comprises determining an address binding associated with the proxy ARP request is removed.

17. The non-transitory computer-readable medium of claim 15, wherein performing ARP reconfiguration comprises:
sending a proxy ARP reconfiguration request to a Station (STA) associated with the removed link;
in response to the proxy ARP reconfiguration request, receiving from the STA any one of (i) a proxy ARP request, (ii) a Dynamic Host Configuration Protocol (DHCP) request, or (iii) a combination of (i) and (ii) to renew an address associated with the removed link; and
renewing the address associated with the removed link.

18. The non-transitory computer-readable medium of claim 15, wherein performing ARP reconfiguration comprises:
receiving any one of (i) a proxy ARP request, (ii) a Dynamic Host Configuration Protocol (DHCP) request, or (iii) a combination of (i) and (ii) to renew an address associated with the removed link; and
renewing the address associated with the removed link.

19. The non-transitory computer-readable medium of claim 15, the method executed by the set of instructions further comprising:
updating a new address learned during the proxy ARP reconfiguration with one or more Multi-Link Device (MLD) links.

20. The non-transitory computer-readable medium of claim 15, the method executed by the set of instructions further comprising:
creating a multicast group of one or more MLD links for sharing address updates created during the proxy ARP reconfiguration.
